(19) United States
(12) Patent Application Publication
(10) Pub. No.: US 2009/0289414 A1
(43) Pub. Date: Nov. 26, 2009

(54) DISPENSER FOR HOLDING PLAYING CARDS

(75) Inventors: Anthonie Hendrik Bergman, Eindhoven (NL); Michel Marcel Jose Decre, Eindhoven (NL); Hubertus Maria Rene Cortenraad, Maastricht (NL); Elmo Marcus Attila Diederiks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,822

(22) PCT Filed: Jan. 24, 2006
(86) PCT No.: PCT/IB06/50255

§ 371 Date: Jul. 26, 2007

(30) Foreign Application Priority Data
Jan. 31, 2005 (EP) 05100606.2

(51) Int. Cl. A63F 1/14; G06F 3/12

(52) U.S. Cl. 273/149 R; 358/1.15

(57) ABSTRACT

Dispenser (18) to accommodate electronic cards (1). The electronic cards (1) have a layer on which a predetermined image is to be provided. The dispenser (18) has an opening (24) for allowing the electronic cards (1) to be removed from the dispenser (18). The dispenser also has an imaging unit (26) to provide the image on the layer when the electronic cards (1) pass the opening (24). The dispenser may be connected to a game controlling system.

### FIELD OF THE INVENTION

The invention relates to a dispenser arranged to hold and produce gaming cards.

### BACKGROUND OF THE INVENTION

Gaming cards and decks are currently made of paper or cardboard paper. Each game necessitates its own deck, and new versions, for instance, require the user to buy a new set of cards. In some games where decks are mixed from several original card sets and can be arranged between playing legs, sorting the cards can be a tedious task. Moreover, manually mixing cards provides additional wear.

Many card games are also available either on a personal computer or on specialized gaming apparatus. Also card games are available on the Internet allowing network gaming.

US 2001/0034258 discloses game elements used when playing board games. Such game elements comprise for instance playing cards. Generally, an image will be present on a playing card. The image is static and cannot be modified. US 2001/0034258 proposes “customized” playing cards. For instance, in a trivia game, a customized playing card may be a card that has a new question on it relating to an event that has recently occurred, e.g. who the winner was of an important recent sports tournament. These customized playing cards may be downloaded from a game provider to a game receiver, who subsequently prints the cards. A disadvantage of the development disclosed in US 2001/0034258 is that the playing card itself is not reused.

On the other hand, options for electronic paper, like electrophoretic-ink from the firm E-ink (United States of America) are currently being generated. These laminated systems of black-and-white particles can be addressed by applying an electric field across them, to obtain structured grey scale pixels that do not need a sustained electric field to retain their grey level. This property is called “bistability”. Such electronic paper has not been proposed for use in the field of gaming cards.

### SUMMARY OF THE INVENTION

Electronic card games that are nowadays known do miss the charm of handheld attributes. Therefore, there is a need for playing card games with electronic cards that can be placed at any position on a table and/or held in the hand while playing a game.

Therefore, in a first embodiment, the invention provides a dispenser arranged to accommodate electronic cards, said electronic cards comprising at least a layer arranged to receive a predetermined image, said dispenser further comprising an opening for allowing said electronic cards at least to be removed from said dispenser, said dispenser further comprising an imaging unit, said imaging unit being arranged to provide said image on said layer when said electronic cards pass said opening.

In this embodiment, only a single set of cards is needed for a plurality of different games one would wish to play. Any card layout (pattern) can be realised by the imaging unit. The user of the dispenser has a large degree of flexibility in giving cards a specific function. Also the playing cards can be reused for a different purpose.

When playing an electronic board game, a controller can adapt an electronic playing board. However, by using the invention, the controller can now also control the distribution and/or content of gaming cards.

The imaging unit may be arranged to electronically “shuffle” the images to be provided on the cards before imaging on the cards is started. Thus, as frequent manual shuffling wears cards, the invention may extend the period during which the cards can be utilized since manual mixing is not necessary anymore.

In an embodiment, the dispenser further comprises a guiding mechanism for guiding said electronic cards through said opening. This guiding mechanism ensures that the motion of the card is smooth such that the imaging process on the electronic cards is more accurate.

In a further embodiment, the imaging unit is in communication with a game system, the imaging unit being arranged to receive data representative for the image from the game system. Then, an updated or new game does not require the purchase of new cards. It suffices to upload the most recent images from the game system to the imaging unit. The imaging unit will transfer the image to the cards, when they are drawn.

In a still further embodiment, the invention relates to a computer arrangement comprising a processor, an imaging head and a memory, said processor being arranged to communicate with said imaging head and said memory, said memory storing instructions and data, said data comprising at least one set of images, each set of images relating to a game, the processor being arranged to select images from said at least one set of images in a predetermined order in accordance with rules stored in said memory, said rules including at least one of randomization and a reference to teaching rules.

Such a computer arrangement has great flexibility in imaging in a specified order. E.g., one can program the computer to select and provide images of a card game in an order which suites teaching purposes or which replays an earlier card game, e.g. a bridge game from a tournament.

Finally, the invention relates to a method of providing images on cards, comprising:
storing instructions and data a memory, said data comprising at least one set of images, each set of images relating to a game;
selecting images from said at least one set of images in a predetermined order in accordance with rules stored in said memory, said rules including at least one of randomization and a reference to teaching rules;
providing said selected images on said cards in said predetermined order.

The invention will now be described with reference to the accompanying drawings which are only intended to show one or more examples but not to limit the scope of protection which is only limited by the annexed claims and their equivalents. In the drawings:

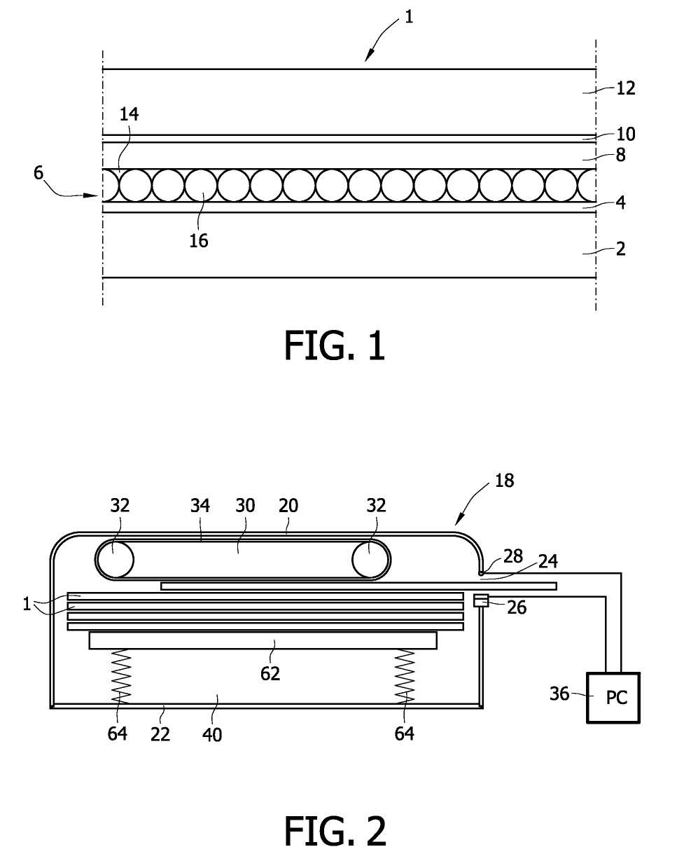

FIG. 1 shows a cross section of an example of an electronic playing card,

FIG. 2 shows a dispenser for a plurality of cards as shown in FIG. 1, according to an embodiment of the invention,

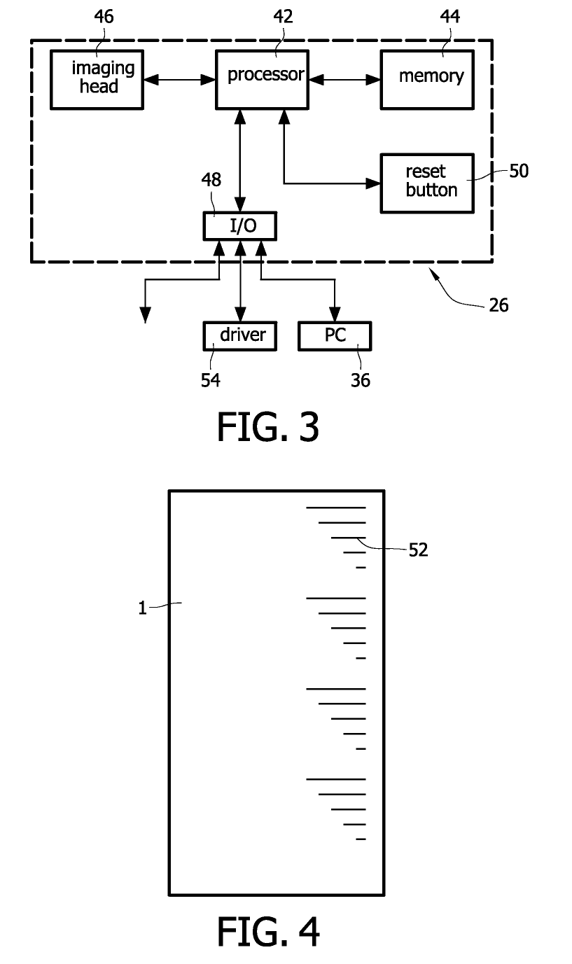

FIG. 3 shows some details of an imaging unit that can be used in the arrangement of FIG. 2 and

FIG. 4 shows an example of a playing card with some fiducial signs.

### DETAILED DESCRIPTION OF EMBODIMENTS

In the present invention, that will be explained in detail below, an altogether new approach to card games is proposed, i.e., by replacing printed cardboard cards with electronically writable cards. Those writable cards may be “soft” and easy to manipulate by hands. The cards may be, in one embodiment, optically-addressable electrophoretic display flexible substrates having the size of a conventional playing card. Such cards, hereinafter called “electronic cards”, can be stored in a dispenser from which the cards may be drawn one-by-one, either manually or automatically, and that provides a writing device used to write the electronic cards when they are drawn. Such a writing device will below be referred to as “imaging unit”, whereas “imaging” will be used to refer to any action to provide an image on the card, either optically, electronically, etc. When the electronic card is drawn it is, e.g., optically-addressed or written into its new state by the imaging unit which state is readable by the human eye. The cards when being written remain “indefinitely”, i.e. during their lifetime, in their written state. The cards can be re-filled in the dispenser after which they can be re-written. The dispenser comprises, e.g., such an imaging unit at an exit slit. When the card is re-written any existing pattern is overwritten, most likely after a full reset action. A processor controls the patterns (or images) to be written on the cards.

In one example of the present invention, optically addressable electrophoretic displays having the size of conventional cards are used as electronic cards. A cross section of an example of such an electronic card 1 is shown in FIG. 1. The electronic card 1 comprises a back foil 2, a back electrode 4, an electrophoretic layer 6, a photoconductive foil 8, a front electrode 10 and a front foil 12. The electrophoretic layer 6 comprises microcapsules 16 and a binder 14 in between the microcapsules 16. Such electrophoretic displays are known from the prior art, e.g., from WO 2004090624, which is incorporated herein by way of reference. The way in which pixels of such an electrophoretic display can be addressed is described in this prior art document and will not be repeated here. It is to be understood that other examples of electronic cards (be it existing ones or ones still under development) can be used too.

In FIG. 2, an example of a dispenser 18 for accommodating electronic cards 1 such as are described in connection with FIG. 1, is shown. The dispenser 18 comprises a casing 20 and a removable casing bottom 22. The dispenser 18 comprises an opening 24. The dispenser 18 further comprises an imaging unit 26 that is arranged to address pixels in the electronic cards. The imaging unit 26 may be arranged in the vicinity of the opening 24, or somewhere else in the interior or exterior of the dispenser 18 as long as it is located within reach of the electronic cards 1 so that it is possible for the imaging unit 26 to apply a predetermined image on the electrophoretic layer 6 of the playing cards 1.

FIG. 3 shows some details of an embodiment of imaging unit 26. The imaging unit 26 comprises a processor 42 connected to a memory 44, an imaging head 46, a reset button 50 (optional) and an I/O device 48. The memory 44 stores one or more images of pictures that can be provided on the electronic cards 1 by the imaging head 46. The images may relate to one or more different card games and may be stored in different sets, each set being associated with one (card) game. The memory 44 also stores one or more computer programs to be run by processor 42 to perform its functions like reading from and writing to memory 44, and writing to the electronic cards 1 via imaging head 46. The memory 44 may be implemented by a mixture of different types of memories, like RAM, ROM, EEPROM, discs, memory sticks, etc. as will be apparent to persons skilled in the art.

The imaging head 46 is chosen to correspond with the method to be used for writing the cards 1. The I/O device 48 may be used by processor 42 to communicate with other devices such as a personal computer 36 that is further explained below, and a driver 54 that is also explained below. The reset button 50 may be operated by a user.

In one embodiment, the dispenser 18 functions in the following way. Via the opening 24 a playing card 1 can be removed by a player from (or inserted into) the dispenser 18. When the electronic card is removed from the dispenser, a predetermined pattern is written on the electrophoretic layer 6, by the imaging unit 26. The pattern may be quite arbitrarily, which offers the advantage that the dispenser 18 can be used to supply playing cards for a large number of different card games. The imaging unit 26 may be programmed to provide an arbitrary one of a set of images relating to one card game and keep track of the images already printed for that card game and only provide an image that has not been provided yet (to prevent double cards from being in a play). Such cards with arbitrary images can be handed out to persons involved in a card game without such a person having to “shuffle” the provided cards again since the imaging unit 26 can do the “shuffling” electronically before imaging. To do this, the imaging unit 26 selects an arbitrary, not yet used image from a set of images associated with one game and being stored in its memory 44 and afterwards stores a reference to the selected and provided image in its memory 44 to prevent double imaging. A user may push the reset button 50 to start a new game and instruct the processor 42 to no longer take into account the images already provided. A reset may also be implemented via the I/O device 48 or automatically.

As an alternative, the pattern (or the fully reset action) may be applied on electronic cards 1 when they are returned into the dispenser 18 via opening 24. Then, the dispenser 18 reduces the time needed to distribute playing cards 1 when a new game is started. In this case, the cards 1 associated with one game may be distributed relatively fast by simply opening the casing bottom 22 and taking them out via the bottom side.

The dispenser 18 may further comprise a detector 28 positioned in such a way that it is possible to monitor the position of an electronic card 1 with respect to the imaging unit 26 when such an electronic card 1 is drawn from the dispenser 18. The detector 28 is connected to the processor 42 of imaging unit 26 via I/O device 48 and will control the imaging unit 26 as a function of the position of the playing card 1 as registered by the detector 28. The detector 28 may be triggered for instance by fiducial signs (or “markers”) present on the card 1. FIG. 4 shows how such fiducial signs may look like. In FIG. 4, fiducial signs 52 are shown that have a different length as a function of position. The length may be decreasing from a maximum length to a minimum length. The signs form a pattern. There may be one such pattern or several such patterns. Of course, all kinds of different signs may be used to indicate a position on the cards 1. The markers may be present on the principal surfaces (front/back) of the card 1 or on the sides. In this way, the position of the card 1 with respect to the imaging unit 26 is relatively well defined and it is possible to apply the predetermined image very accurately on the playing card 1. An electronic card 1 drawn by a user from the dispenser 18, will generally not have a uniform velocity. In this case it is in particular advantageous to have a detector 28 present in the dispenser 18. Because when the velocity of the playing card 1 is relatively high, the pattern must be applied with a relatively high velocity on the card 1. On the other hand, when someone extracts the card 1 from the dispenser 18 rather slowly, the speed with which the pattern is inscribed on the card must be adjusted accordingly.

Additionally, or alternatively, the dispenser 18 may comprise a guiding mechanism 30. The guiding mechanism 30 may comprise a pair of tiny wheels 32 or a pair of tiny wheels 32 interconnected by a belt 34. The wheels 32 may be driven by a driver 54, shown in FIG. 3, which is connected to the processor 42 via I/O device 48. The driver 54 may, thus, be controlled by the processor 42 whereas the processor 42 may control the speed of feeding out cards 1 from the dispenser 18 to keep better control of a regular imaging process. The guiding mechanism 30 are used to eject an electronic card 1 from the dispenser 18 and eliminate the need to do this manually. Moreover, the guiding mechanism 30 ensures that the motion of the card is uniform (less difference in velocity) when the predetermined image is written on the card. Thus, then, there is less need for applying the detection means 28 described above. The guiding mechanism 30 may be mechanical, pneumatic, magnetic or otherwise.

The guiding mechanism 30 may also function as a detector and, for instance, comprise only one wheel. When the card 1 is removed from (or inserted into) the dispenser 18 such a wheel will be rotated by the card 1. The number of rotations is related to the position of the card 1 with respect to the imaging unit 26. In such an embodiment, a sensor (not shown) counting the number (or degree) of rotations of the wheel will be applied. Such sensors are known as such. By feeding the number of rotations from the sensor to the processor 42, the processor 42 is able to calculate the position of the card 1 and to provide images to the card 1 accordingly.

The imaging unit 26 may be an optical scanning device such as a (scanning) laser beam or a light emitting diode (LED) (or an array of LED's). These technologies have proven to work well in practice. These light sources locally change the resistance of the photoconductive foil 8 of the playing card 1 in FIG. 1. In principle, the use of infra red (IR) radiation may also be contemplated, as many materials exist with a resistance changing significantly as a function of temperature. In this case the photoconductive foil 8 will be replaced by such a material.

In a further embodiment, the imaging unit 26 and detector 24 are in communication with a game system, such as the personal computer (PC) 36. The communication may be effected by wire or may be wireless. New games or updates of games can be uploaded to the imaging unit 26 by use of the PC 36. Of course, games can also be uploaded from the Internet via the I/O device 48.

In addition, the dispenser 18 may be equipped with a card upload system 40. The card upload system 40 engages the playing cards 1 in the dispenser 18 such that the playing cards 1 are positioned in front of the opening 24, to allow the playing cards 1 to be removed from the dispenser 18. The card upload system 40 may, for instance, comprise a floor 62 attached to the bottom 22 of the dispenser 18 with springs 64.

In an alternative fashion, the invention relates to generation of cards with images printed on them according to some predetermined criterion. In this alternative embodiment, using electronic cards 1 and using the dispenser 18 is not necessary. The cards can be made by printing images on paper or cardboard paper cards by using a (colour) printer device controlled by a suitably programmed computer. Thus, the general setup of the system needed looks like the one shown in FIG. 3, be it that the imaging head 46 may be a printing head for printing with ink. The computer may download images relating to games from the Internet or read such images from a data carrier, like a floppy disc, a CD-ROM, a DVD, a memory stick, etc. To each game, a set of images is related that are stored in the computer's memory. The computer is arranged to select images from a set of images stored in its memory. The order may be arbitrary (random generation) or the order may have a specific pre-defined sequence. For instance the selection by the computer may relate to a distribution of cards for teaching rules of game or to play a bridge game that has been played at some tournament before. The computer may be provided with input devices like a mouse, a keyboard, a trackball, etc. to receive input from a user. Then, the user may be allowed to specify to the computer a predetermined card image from the set of images.

Additional benefits associated with gaming cards that are controlled by the gaming system are, e.g.,
1. the possibility that the system determines the next card to be drawn and as such can take care the game stays exciting for the players, e.g. by handing out ‘better’ cards to loosing players.
2. levels can be introduced to ‘classical’ (board/card) games, e.g., more sophisticated (or more difficult) cards can be introduced once the players are more familiar with the game.
3. During the game new cards may become available or can be bought on-line or exchanged with other gaming systems. Only data transfer is necessary for this action.

In many respects these electronic cards open new opportunities for game design.

1. Dispenser arranged to accommodate electronic cards, said electronic cards comprising at least a layer arranged to receive a predetermined image, said dispenser further comprising an opening for allowing said electronic cards at least to be removed from said dispenser, said dispenser further comprising an imaging unit, said imaging unit being arranged to print said image on said layer when said electronic cards pass said opening.

2. Dispenser according to claim 1 characterized in that said imaging unit is arranged to provide said image on said layer when said electronic cards pass into said dispenser.

3. Dispenser according to claim 1 characterized in that said dispenser further comprises a detector in communication with said imaging unit, said detector being arranged to determine a position of an electronic card during removing said electronic card via said opening, said detector being arranged to send a card position signal to said imaging unit.

4. Dispenser according claim 1 characterized in that said dispenser further comprises a guiding mechanism for guiding said electronic cards through said opening.

5. Dispenser according to claim 1, characterized in that said imaging unit is arranged to provide an image on an electrophoretic card.

6. Dispenser according to claim 1 characterized in that said imaging unit is in communication with a game system, said imaging unit being arranged to receive data representative for said image from the game system.

7. Dispenser according to claim 1 characterized in that said dispenser further comprises a card upload system arranged to position said electronic cards in front of said opening.

8. Dispenser according to claim 1, characterized in that said imaging unit comprises a processor, an imaging head and a memory, said processor being arranged to communicate with said imaging head and said memory, said memory storing instructions and data, said data comprising at least one set of images, each set of images relating to a game, the processor being arranged to select images from said at least one set of images in a predetermined order.

9. Computer arrangement comprises a processor, a imaging head and a memory, said processor being arranged to communicate with said imaging head and said memory, said memory storing instructions and data, said data comprising at least one set of images, each set of images relating to a game, the processor being arranged to select images from said at least one set of images in a predetermined order in accordance with rules stored in said memory, said rules including at least one of randomization and a reference to teaching rules.

10. Computer arrangement according to claim 9, wherein said processor is arranged to select each of said images from said set of images only a single time until said processor receives a reset signal.

11. Computer arrangement according to claim 9, wherein said imaging head is an ink printing head.

12. Method of providing images on cards, comprising:
storing instructions and data a memory, said data comprising at least one set of images, each set of images relating to a game;
selecting images from said at least one set of images in a predetermined order in accordance with rules stored in said memory, said rules including at least one of randomization and a reference to teaching rules;
providing said selected images on said cards in said predetermined order.
